(19) United States
(12) Patent Application Publication
(10) Pub. No.: US 2023/0032734 A1
(43) Pub. Date: Feb. 2, 2023

(54) SPACE VENDING MACHINES

(71) Applicant: Stephen Madison Byrd, Upper Marlboro, MD (US)

(72) Inventor: Stephen Madison Byrd, Upper Marlboro, MD (US)

(21) Appl. No.: 17/489,819

(22) Filed: Sep. 30, 2021

Related U.S. Application Data
(60) Provisional application No. 63/227,091, filed on Jul. 29, 2021.

(51) Int. Cl. G06Q 10/08; G06Q 30/06; G07F 17/00

(52) U.S. Cl. CPC G06Q 10/0831; G06Q 30/0635; G07F 17/0064; G06Q 10/0832; G06Q 50/12

(57) ABSTRACT

The present invention discloses a system and method of delivering food items or products of interests from the space-vending machine housed in a space shuttle or the orbiter to the astronaut's specific location on the International Space Station. More precisely, the orbiter docks into the desired experiment module from where it receives the order and delivers it on the International Space Station.

### CROSS REFERENCE TO RELATED APPLICATIONS

The present application claims priority to U.S. Provisional application with application No. 63/227,091 filed on 29^{th} of Jul. 2021 which are hereby incorporated by reference in its entirety.

### FIELD OF INVENTION

The present invention relates to a system and method of ordering and delivering food and other items of interests including but not limited to consumable items in the International Space Station.

### BACKGROUND OF THE INVENTION

Food delivery and other items of interests is a tedious and unsynchronized process when the actual orderers are astronauts on various space expeditions. Since food is a basic requirement, many a times the conventional stocked and limited variety of food items in the spacecraft is a reason of worry for the resident Astronauts. It is nearly impossible to survive on a partially bland and repetitive diet for months during the space expeditions. The present invention encompasses a method and system for vending food and other items of interests and get them delivered at the preferred location of the orderer in the outer space or the International Space Station (ISS).

Alternately, the growing number of options for cashless transactions is in high demand and impacts more in business, especially for vending machine companies, nowadays it's a more effortless and preferable mode for customers to purchase items without having cash on hand. These machines are also becoming increasingly popular in the retail sector. They are self-serve, and human involvement has disappeared and replaced these machines for effortless activities such as customers check-out. Though the traditional vending machine may be equipped with snacks and sodas but nowadays, the innovations range from multi-media to book dispensers or Twitter-activated soda dispensers to VR retail concepts.

The present invention relates to a system and method of ordering food and other items of interests in the outer space or the International Space Station. The food items are automatically queued in the vending machine after receiving the order request and then dispended in a portable bag or container ready to be delivered to the astronaut in the the International Space Station. The entire process makes it easier for several astronauts to order healthy meals during space exploration..

### DESCRIPTION OF RELATED ARTS

Numerous research studies and prior arts, such as patent and non-patent works of literature, are publically available relating to the conventional vending machine and its methods. For instance, Sprankle et al., in the granted patent U.S. Pat. No. 7,988,015B2, discloses an adjustable storage rack for use in a vending machine.

In another granted patent, U.S. Pat. No. 8,615,473B2, Joel et al. disclosed a method and system for anticipatory shipping package. In the patent application U.S. Pat. No. 8,096,444B2, John etal. teach about the product discharge and delivery system for a vending machine that releases a selected product towards a dispensing chamber for delivery to a consumer.

In the patent application U.S. Pat. No. 9,262,377B2, Garson et al. disclose a method and apparatus used in a vending machine that dispenses products to customers.

Further in the patent application U.S. Ser. No. 10/380,822B2, Paul et al. disclose the systems and methods for wireless authorization at a vending machine via a customer's mobile device. In yet another granted patent application, JP5583662B2, Ashley discloses a Virtual vending machine system and method for communicating with the remote data processing device

In the granted patent application U.S. Pat. No. 9,635,874B2, Gary et al. teach about automatic vending machines that control frozen food product vending machines.

None of the prior arts teaches about the system or method for implementing vending machines and delivering food items or products of interests to the astronauts stationed in the outer space.

### SUMMARY OF THE INVENTION

The present invention discloses a system and method of delivering food items or products of interests from the space-vending machine housed in a space shuttle or the orbiter to the astronaut's specific location on the International Space Station. More precisely, the orbiter docks into the desired experiment module from where it receives the order on the International Space Station. For example, the orbiter carrying the food vending machine will dock into the American experiment module in case the food items are ordered by the astronaut on the American experiment module or experiment laboratory. Experiment module and experiment laboratory can be interchangeably used in the present specification.

Another embodiment of the present invention discloses a system and method in which an astronaut can select and order food items of interest\and get them delivered at their destination in the space.

Yet another embodiment of the present invention discloses a system and method that precisely verifies the coordinates of the astronaut stationed on the International Space Station in order to deliver the packed ordered.

Yet another embodiment of the present invention discloses a system and method of automatically selecting, packing and dispensing food and other items of interests. The ordered items are packed in a thermally insulated container with vacuum and arrayed with the plurality of ordered items.

Another embodiment of the present invention discloses a system and method in which the ordered food items are dehydrated and packed with co-extrusioned layers of polythene.

Yet another embodiment of the present invention discloses a system and method of active communication between the system and orderer's device in order to deliver the food items to the correct location coordinates of the astronauts stationed on the International Space Station.

### BRIEF DESCRIPTION OF THE ACCOMPANYING DRAWINGS

The accompanying drawings illustrate several embodiments of the invention and, together with the description, explain the principles of the invention according to the embodiments. One skilled in the art will recognize that the particular embodiments illustrated in the drawings are merely exemplary and are not intended to limit the scope of the present invention.

FIG. 1 illustrates a basic network diagram of GPS(Global Positioning Satellite) navigation system.

FIG. 2 illustrates a flowchart representing an overview of the present invention.

FIG. 3 illustrates a network diagram of yet another embodiment of the present invention.

FIG. 4 illustrates a flowchart representing another embodiment of the present invention.

FIG. 5 illustrates a block diagram of yet another embodiment representing the apparatus and its interconnections

FIG. 6 illustrates a block diagram of the free space optical communication system for wireless transmission.

FIG. 7 illustrates another embodiment of the present invention showing the specially made container packaging for delivery in the International Space Station.

### DETAILED DESCRIPTION OF THE PREFERRED EMBODIMENTS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a consistent meaning in the context of the specification and should not be interpreted in an idealized or overly formal sense unless expressly so defined herein. Well-known functions or constructions may not be described in detail for brevity or clarity.

The terminology used herein is for the purpose of describing particular embodiments only and is not intended to be limiting. As used herein, the singular forms “a”, “an” and “the” are intended to include the plural forms as well, unless the context clearly indicates otherwise.

With reference to the use of the words “comprise” or “comprises” or “comprising” in the foregoing description and/or in the following claims, unless the context requires otherwise, those words are used on the basis and the clear understanding that they are to be interpreted inclusively, rather than exclusively, and that each of those words is to be so interpreted in construing the foregoing description and the following claims.

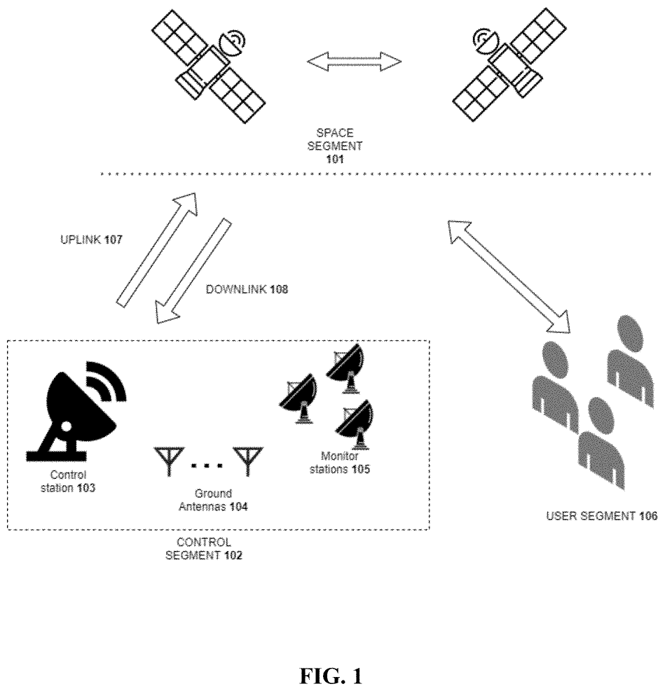

FIG. 1 illustrates a global positioning system (GPS)100 used for navigation purpose. It uses radio signals to track the satellites with shifts in position. System 100 comprises three segments: space segment 101, control segment 102, and user segment 106. Space segment 101 refers to a satellite constellation consisting of operational satellites, each equipped with redundant atomic clocks and tracked by a ground control network, the control segment 102. The control segment 102 is a network of ground facilities comprising control station 103, monitor stations 105, and a group of ground antennas 104. The control segment plays the role of tracking the GPS satellites, monitor their transmissions, perform analyses, and send commands and data to the constellation. Control station 103 provides command and control of the GPS constellation. The monitor station 105, track GPS satellites and collect navigation signals, range/carrier measurements, and atmospheric data and fetches the observations to the control stations 103. Control station 103 uses the data from monitor station 105 to compute precise locations of satellites. It also takes control of system maintenance and resolves the resolution. The ground antennas 104, send commands navigation data uploads, and processor program loads to the satellites. The communication between the ground and the satellites is two-way; the communication from the ground station to a satellite is called uplink 107. And the reverse from a satellite to the ground is called downlink 108. The communication received by the spacecraft and the one received by the earth happens at the same time. The space segment 101 has the main functions: to transmit radio-navigation signals, to store and retransmit the navigation message sent by the Control Segment. These transmissions are controlled by highly stable atomic clocks onboard the satellites.

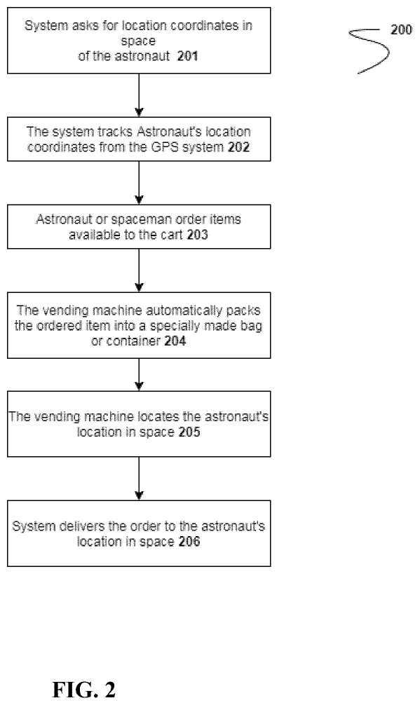

FIG. 2 illustrates another embodiment of the present invention. It shows an overview of the system and method of the implementation of the present invention. System 200 represents placing an order of food and other consumable items in the space to the delivery location of an astronaut in the International Space Station (ISS). At 201, the system requests the astronaut's location coordinates in the International Space Station and further tracks their experiment module location coordinates from the navigation system at 202. For example, an astronaut from the Russian experiment module orders food items then the system fetches the location coordinates of the Russian astronaut's experiment module and deliver's the food items by docking the orbiter or the space shuttle into the Russian experiment module on the International Space Station. The astronaut or the space tourist then orders and selects the items of interest and adds them to the checkout cart at 203. The vending machine housed in the space shuttle or the orbiter automatically packs the ordered items into a specially made container for delivery at 204. The specially made container is a thermally insulated storage container with a removable lid with thermal insulation provided externally. The storage container may be any light-weight alloy metal such as aluminum which is compatible with the space conditions. At 205, the shuttle containing the vending machine orbits in space and locate the astronaut's precise coordinates and finally delivers the ordered item to the location in the space, at 206. The shuttle or orbiter containing the vending machine docks to the desired location on the International Space Station.

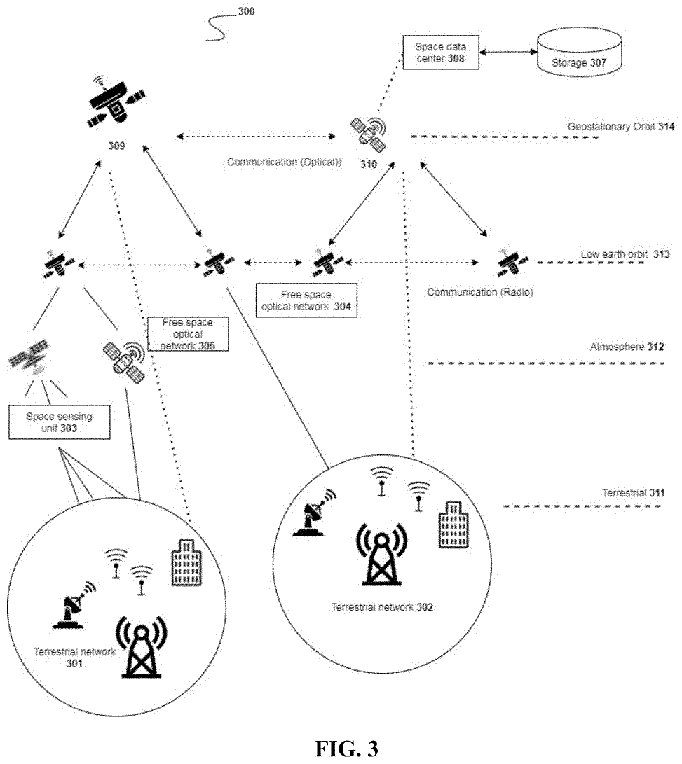

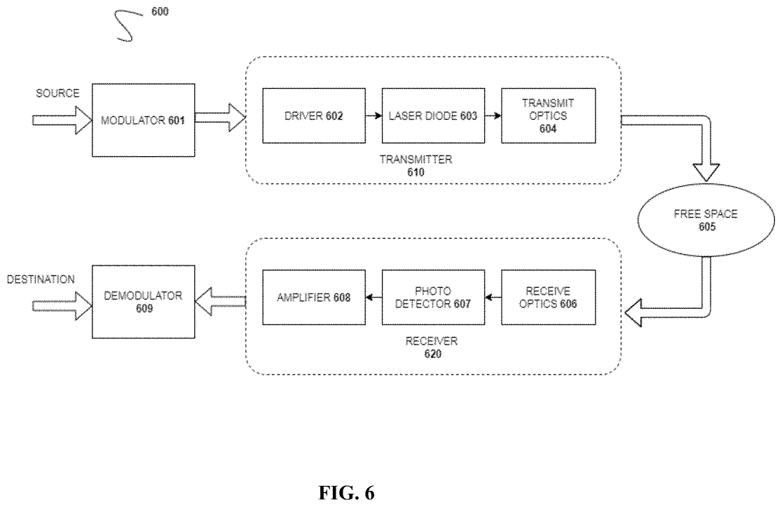

FIG. 3 illustrates a network diagram of yet another embodiment of the present invention describing the transaction and delivery of ordered items in space between the space shuttles. System 300 depicts multiple orbits, from the ground station 311, the atmosphere 312, the low earth orbit 313, to the geostationary orbits 314. The ground station or earth station, the terrestrial 311, includes terrestrial networks (301,302) comprising: control station, antennas, monitoring stations, etc., that transmits and receives radio signals to/from different application satellites (such as remote sensing satellites, weather satellites, navigation satellites and soon) that is, at the atmospheric level 312, at Low Earth Orbits 313, and Geostationary Orbits at 314. In addition, there is a space sensing unit 303 that uses sensors to trace the signal strength from the GPS satellites to the ground. In addition, they are connected to the ground by optical wireless communication networks to form a constellation, and distributed computing enhances various data processing. It also provides access to terrestrial networks (301,302) through mobile devices for ultra-wide service coverage. The communication between the satellites and the ground station occurs through a free-space optical communication system (304,305), described in FIG. 6.

At the geostationary orbits 314 or above the low earth orbit 313, the space shuttles or spacecraft (309,310)revolves. The space shuttles or orbiter inter communicates by means of the free-space optical communication system. (FIG. 6 details free-space optical communication system). The space shuttle 310 houses the space vending machine that carries the products or food items for delivery at the destination of the astronaut on the International Space Station. It also has an inbuilt space data server 308 that stores the information at storage 307 and retrieves transaction data for purchase or delivery of food items and other consumable products. Thus, the overall system illustrates the system or method of product delivery at the destination of the astronaut on the International Space Station.

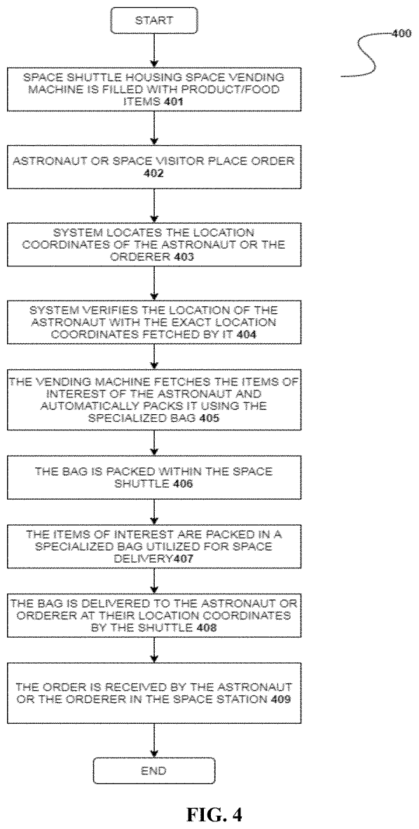

FIG. 4 illustrates a flowchart representing an embodiment of the present invention. It depicts system 400, which will be implemented in space to deliver ordered items of interest from a space vending machine housed in a space shuttle to the astronauts or space tourists stationed in outer space. Basically, at 401, a space vending machine housed in a space shuttle selects, packs and dispenses food items for delivery as per the requisites of the astronaut. The astronaut space tourist places an order through the mobile application system at 402. The system then traces the location coordinates of the astronaut on the International Space Station at 403. And at 404, the system verifies it with the location coordinates of the astronaut or the orderer. Once the order is placed, the vending machine fetches the ordered items and automatically packs them into a thermally insulated specialized container or bagat 405. The ordered items for delivery are further kept in the array section of the thermally insulated specialized container. The ordered items may be a dehydrated food items that may be rehydrated for bite-sized foods. At 406, the main bag or container containing ordered items is packed. Further, at 407, the specialized container is ready for delivery, and at 408, the container is delivered to the astronaut or orderer at their location coordinates. Finally, at 409, the order is delivered and received by the astronaut or the orderer in the International space station. Additionally, the temperature and weight of the final order in the delivery container is assessed before the scheduled delivery. In case the final order in the delivery container exceeds the threshold temperature and weight parameters, the order gets canceled.

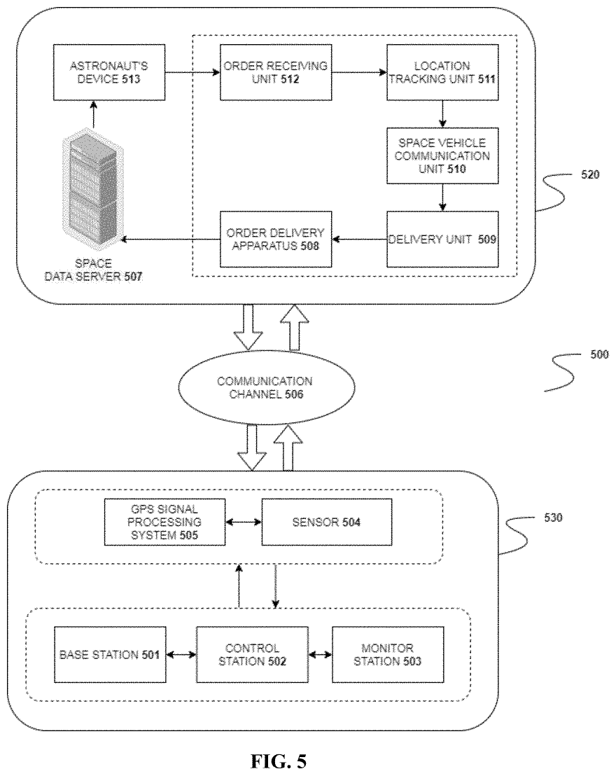

FIG. 5 illustrates a block diagram 500 of yet another embodiment representing the apparatus and its interconnections with the present invention. Block diagram 500 illustrates the primary apparatus involved in the space communication system. Block 530 represents the device units that is primarily employed in the ground station or on earth. Block 520 represents the major apparatus employed for intercommunication between and the orbiter carrying the space vending machine and the International space station. Both the apparatus used in the ground station 530 and the space segment 540 undergoes communication through channel 506. The ground station comprises a base station 501, a master control station 502, a monitor station 503, sensors 504, and a GPS signal processing system 505. The base station 501 is a GPS(global positioning system) receiver that collects GPS measurements at a known location. It includes components such as an antenna, a GPS receiver, and a device to which the GPS data is logged. A base station provides reference data that can be used to increase the accuracy of GPS data collected in the field. The control station 502 consists of a global network of ground facilities that track the GPS satellites, monitor their transmissions, perform analyses, and send commands and data to the constellation. It performs satellite maintenance and anomaly resolution, including repositioning satellites to maintain optimal constellation. The monitor station 503 tracks GPS satellites, collects navigation signals, range/carrier measurements, and atmospheric data. Further, it feeds the observations to the control stations. The ground station or the earth also comprises GPS sensors 504, which are receivers with antennas that use a satellite-based navigation system with a network of 24 satellites in orbit around the earth to provide position, velocity, and timing information. The signals received from the satellites and space segments are then processed in the ground with the aid of GPS signal processing system 505. The space segment 520 comprises components that are part of the space vending machine housed in a space shuttle or space vehicle. It includes an order receiving unit 512, a location tracking unit 511, a space vehicle communication unit, a delivery unit and an order delivery apparatus unit 508. The order receiving unit 512 is the unit that receives the order from an astronaut's device 513. It also accepts the location coordinates from an astronaut's device and sends it to the location tracking unit 511. The system also has a space vehicle communication unit 510 that communicates the order received to the delivery unit 509 of the space vending machine. The vending machine automatically initiates selection and packaging of the ordered items in a special thermally insulated container to become compatible with the space conditions. The space segment 520 also includes a space data server 507 that stores the data related to order, purchase, delivery, etc.

FIG. 6 illustrates another embodiment of the present invention representing the communication channel between satellites and spacecraft in space. Free-space optical communication (FSO) is an optical communication technology that uses light propagating in free space to mean air, outer space, vacuum, or something similar wirelessly transmit data for telecommunications or computer networking. It is a line-of-sight technology that uses lasers to provide optical bandwidth connections in free space.

Block diagram 600 shows a free-space optical(FSO) communication system where free space acts as a communication channel in space that determines the transmission and reception of optical signals. The channel may be atmosphere, space, or vacuum. This mode of communication helps high data rates and increases the transmission and reception rate in both long and short-range applications. The communication system 600 depicted in FIG. 6, has primarily two components: transmitter 610 and receiver 620. This mode of communication uses the emission of optical radiation or laser beams in an open space to transmit data between two points without obstructing the line of sight between them. The system 600 inputs the information source and then passes through a modulator 601. The modulated laser beam is then passed through an optical driver 602 to boost the optical intensity. At the transmitter end 610, it consists of a driver 602, lasers or light-emitting diodes 603 and, and at the receiver 620, it consists of an amplifier 608, signal receivers, such as photodetectors 607. At the transmitter end, the light beam is collected and refocused by means of transmitter optics 604. At the receiver end, the receiver optics 606 collects and focuses the received beam onto the photodiode 607 is passed to an amplifier 608. The photodiode detects changes in the light intensity. At demodulator 609, the communication system receives the demodulated data and recovers the data.

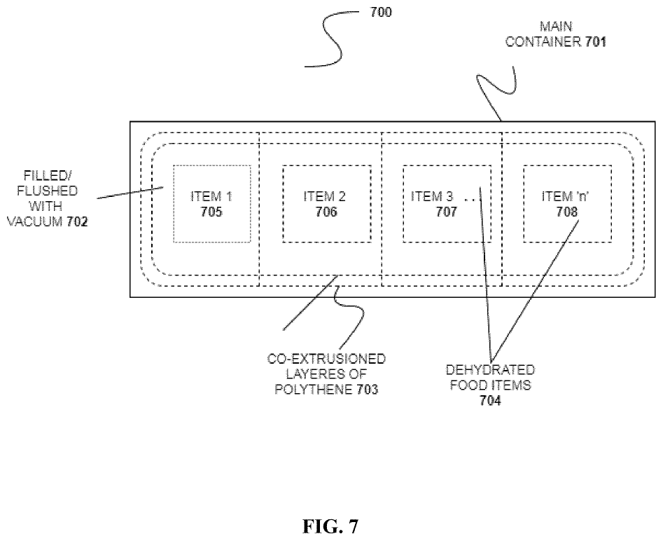

FIG. 7 illustrates another embodiment of the present invention showing the packaging of the specially made bag or container 700 for delivery in outer space. The placed items from the space vending machine are delivered in a special thermally insulated bag or container 700.

Container 700 has an external lid for fetching the ordered items and an outer body made up of alloys such as aluminum, which is compatible with outer space conditions. The inner layer of the container, 703, is provided with co-extrusioned layers of polythene such as nylon/ethylene or viny alcohol or tie layer of polythene or linear low-density polythene material. The inner portion 702 of the container is also filled with vacuum and flushed nitrogen, depending on the food product type. The ordered items (705,706,707,708) are automatically stored in an array of space facilitated in the container. The ordered items may be any form of dehydrated food products, ready-to-consume products, etc.

While a number of preferred embodiments have been described, it will be appreciated by a person skilled in the art that numerous variations and/or modifications may be made in the invention without departing from the spirit or scope of the invention as broadly described. The present embodiments are, therefore, to be considered in all respects as illustrative and not restrictive. The words“orbiter” or, “space shuttle” or“spacecraft”; and “International Space Station” or “space station” or “outer space” and “Experiment module” or “experiment laboratory” and “bag” or “container” have been used interchangeably in the above-discussed specification. Therefore, the present invention is not limited to the above embodiments that the person should be made under the inspiration of this novel utility of the present invention the same or similar technical solution has, fall within the scope of the present invention.

I/We claim:

1. A computer implemented method of food delivery in space, the method comprising:
receiving by a computer, the order for food and other consumable items of interest from an astronaut in the international space station;
a computer tracking the location coordinates of the orderer with the help of a navigation system;
a vending machine automatically packing the ordered items into a thermally insulated special delivery container;
the shuttle orbiting in the space tracking the astronaut's location coordinates and concluding the order delivery.

2. A computer implemented method of food delivery in space as claimed in claim 1, wherein the delivery container is thermally insulated with a removable lid; the container may only bear a certain threshold of weight per order delivery.

3. A computer implemented method of food delivery in space as claimed in claim 2, wherein the delivery container is a light-weight alloy metal preferably aluminum which is compatible with the outer space conditions.

4. A computer implemented method and system of food delivery in space as claimed in claim 1, wherein the vending machine is housed within the space shuttle.

5. A computer implemented method of food delivery in space as claimed in claim 4, wherein the vending machine automatically initiates selection and packaging of the ordered items in a special thermally insulated container to become compatible with the space conditions.

6. A computer implemented method of food delivery in space according to claim 5, wherein the temperature and weight of the final order in the delivery container is assessed before scheduled delivery.

7. A system of food delivery in space comprising:
a processor executing the instructions to determine whether the ordered cart items are being selectively fetched and packed by the vending machine;
a processor executing the instructions to determine the overall temperature and weight of the delivery container;
a processor executing the instructions to determine the location coordinates of the orderer in the outer space;
a processor executing the instructions to receive plurality of status updates on the order history, purchase details and delivery of the food and other consumable items.

8. A system of food delivery according to claim 7, wherein the space data server stores the data related to order history, purchases and delivery of the food and other consumable items.

9. A system according to claim 7, wherein the processor executes the instructions to determine the temperature and weight of the final order in the delivery container.

10. A system according to claim 7, wherein the processor executes the instructions to cancel the order in case the final order in the delivery container exceeds the threshold temperature and weight parameters.

11. A computer program product, comprising a computer code integrated onto a non transitory storage medium wherein:
a computer code determines the packaging status of the delivery container;
a computer code determines the final weight and temperature of the delivery container;
a computer code navigates to the location coordinates of the orderer;
a computer code determines the delivery status of the final order.

12. A computer program product according to claim 11, wherein a computer code executes cancellation of the order in case the final order in the delivery container exceeds the threshold temperature and weight parameters.
